(19) United States
(12) Patent Application Publication
(10) Pub. No.: US 2024/0273645 A1
(43) Pub. Date: Aug. 15, 2024

(54) METHOD OF SELECTING SHIMS NEEDED WHEN PERFORMING AN ALIGNMENT OF SHAFTS OF A FIRST MACHINE AND A SECOND MACHINE

(71) Applicant: AKTIEBOLAGET SKF, GOTEBORG (SE)

(72) Inventor: Sylvain Georges Henri HUMBERT, Saizerais (FR)

(21) Appl. No.: 18/426,434

(22) Filed: Jan. 30, 2024

(30) Foreign Application Priority Data
Feb. 6, 2023 (DE) 102023200944.7

(51) Int. Cl. G06Q 50/04; G01B 5/14

(52) U.S. Cl. CPC G06Q 50/04; G01B 5/14

(57) ABSTRACT

A method of aligning the shafts of first and second machines includes a) determining a total required shim thickness needed to raise a portion of the first machine relative to a first machine support to align the shaft of the first machine with the shaft of the second machine, b) providing a set of shims, each of the shims having a thickness, c) providing to a computer processor the thickness of each shim in the set of available shims, d) automatically determining by the computer processor at least one subset of the set of available shims required to provide the total required shim thickness, e) selecting one of the at least one subset of shims from the set of available shims, and f) inserting one of the at least one subset of shims between the portion of the first machine and the first machine support.

### CROSS-REFERENCE

This application claims priority to German patent application no. 10 2023 200 944.7 filed on Feb. 6, 2023, the contents of which are fully incorporated herein by reference.

### TECHNOLOGICAL FIELD

The present disclosure is directed to a method of selecting shims needed when aligning the shafts of a first machine and a second machine and using the shims to align the shafts. The disclosure is also directed to a set of shims required when aligning the shafts of a first machine and a second machine.

### BACKGROUND

At power transmission between rotary shafts, for example via coupling, a first shaft can be part of a first machine such as a motor, and a second shaft can be part of a second machine such as a pump, a fan, a gear box, or other. The first shaft may be referred to as a driving shaft, and the second shaft may be referred to as a driven shaft.

A major part of keeping machinery running smoothly involves regular maintenance, upkeep and ensuring that the machinery is kept lubricated and properly aligned. Correct shaft alignment ensures the smooth, efficient transmission of power from the first machine to the second machine.

However, when first and second shafts on rotating machinery are misaligned, the risk of costly, unplanned machine downtime rises dramatically. Failure to align the shafts properly increases the amount of stress on the units, resulting in a range of potential problems that ultimately can seriously impact a company's bottom line. Shafts misalignment is responsible for as much as 50 percent of all costs related to machinery breakdowns.

Misalignment increases friction and results in excessive wear and energy consumption and the possibility of premature breakdown of the machines having the shafts. Misalignment also causes excessive wear on bearings and seals which can lead to premature failure. Furthermore, misalignment leads to premature shafts and coupling failure, to excessive seal lubricant leakage, to failure of coupling and foundation bolts, to increased vibration and noise.

Misalignment occurs when the axes of the first shaft and the second shaft are not in line with each other. Misalignment can comprise parallel misalignment or angular misalignment or a combination of both. With parallel misalignment, the axes of both shafts run parallel to one another, but they are offset—that is, they are parallel but not colinear. With angular misalignment, the shafts run at an angle to one another.

Accordingly, proper shaft alignment is one of the most important factors influencing rotating equipment performance and can reduce or eliminate the risk of breakdowns, reduce unplanned downtime that results in loss of production, and minimize maintenance costs.

Machines need to be aligned in both the horizontal and vertical planes.

When performing a shaft alignment, different methods can be used. Three of them are visual inspection combined with a straightedge or ruler, the use of dial indicators, or the use of laser guided tools.

The traditional method that includes visual inspection combined with a straightedge or ruler is still in common use. The straightedge is positioned on two bearings supporting one or more shafts while the maintenance inspector visually assesses whether or not the components are properly aligned. Such rough method has the advantage of being quick and relatively easy.

Dial indicators represent another traditional method of measuring misalignment. Dial indicators do offer a higher degree of accuracy.

The method using laser-guided tools is quick, accurate, easy to use. In addition, it delivers consistently better accuracy than dial indicators and it does not require special skills to obtain accurate results virtually every time. Shaft alignment laser guided tools typically include two units, each capable of emitting a precise laser beam and detecting a laser beam from its mate, plus a handheld control device.

Laser alignment methods represent a marked improvement as compared to traditional methods. A laser-based shaft alignment device allows one to adjust alignment with far more speed and accuracy than either the straightedge or dial method.

Whichever method is used, very often shims must be inserted below one foot or various feet of at least one of the machines to align the shafts with respect to each other.

In practice, a user lifts a machine by a few millimeters to then insert shims under the feet. The user performs mental calculations and chooses shims available in a set; he experiments, adds, or removes shims until he obtains the correct wedging. This method usually works, but still has some drawbacks.

One of them is the risk of a miscalculation. In this case, the height correction will be excessive or insufficient. If the user doesn't verify his work a wedging error remains, and the shafts will not be properly aligned. If the user verifies his work by a control measure, he can correct his mistake, but this is time consuming. Indeed, if the height correction is excessive, the user may remove one shim to replace it with one or more others. On the contrary, if the height correction is insufficient, the user may add one or more shims to reach the right value. Because the user may not remember the value of the shims already put in place, it will take time to find a suitable additional shim. Also, the user does not necessarily see that he can remove shims to put others or is it too complicated to do it by mental calculation. In both cases, excessive or insufficient height, there is a risk due to miscalculation.

Other drawbacks sometimes appear with shims, in fact when too many are used.

For example, a height correction may be insufficient and accordingly the user adds one or more shims to reach the right value. With too many shims, the accuracy is impaired due to a greater number of gaps between the shims. The more shims, the more clearance such that, for example, 3 shims that are each 0.3 mm thick do not function the same as a single 0.9 mm shim due to the presence of the gaps. Further, the alignment adjustment action is painful. Using too many shims also means that the connection between a machine and the base on which it rests can be too flexible or insecure. This affects alignment accuracy. Too many shims also increase the risk of corrosion. The last reduces the thickness of the shims and alters the alignment of the shafts.

### SUMMARY

In view of the foregoing one aspect of the disclosure is to make shaft alignment easier and in particular to reduce the risk of error, or even eliminate it, when selecting shims from a set. This is to avoid miscalculation. Another aspect of the disclosure is to minimize the number of shims required to obtain a proper adjustment.

An embodiment of the disclosure comprises a method of selecting shims needed when performing an alignment of shafts of a first machine and a second machine. This method comprises the steps of: providing to an algorithm values of the shaft's misalignment, providing to the algorithm the values of the thicknesses of each shim of a set of available shims, and extracting from the algorithm a combination of shims to compensate the misalignment values of the shafts.

Consequently, it becomes simple to select shims from a set: just read and consider the result given by the algorithm. The risk of error is reduced, and the shaft alignment is easier.

The method may comprise a step in which the algorithm determines a combination of shims that includes up to three shims, the determined combination of shims being the extracted combination of shims.

Consequently, the wedging will be done with only one, or two, or at most three shims. Only necessary shims are used. The method simplifies the wedging operation. The risk of miscalculation is reduced, and wedging accuracy is better. Working speed is increased, and the time required to complete the alignment is shorter. Among the benefits that flow from the invention, we can notice better achievement of shafts alignment tasks, greater machine's reliability, reduced operating and maintenance costs.

Moreover, as few shims are used, the accuracy is improved due to a smaller number of gaps between the shims. The less shims, the less gaps. Further, the alignment adjustment action is easy. Using only a few shims also means that the connection between a machine and the base on which it rests retains sufficient rigidity. This preserves alignment accuracy. With only a few shims the risk of corrosion is limited. The thickness of the shims and the alignment of the shafts are stable.

The method may comprise a step in which the algorithm determines the thickness of each shim. Since its thickness is indicated on each shim, it is easy to make sure that the chosen shim is the right one.

The method may comprise a step for measuring misalignment in the absence of shims. This allows to know the original value of the misalignment.

The method may comprise a step for measuring misalignment in the presence of shims. For example, it is useful for a maintenance operation.

The method may comprise a step of inventorying the set of shims. Accordingly, the computing device can consider the practical constraints to calculate the shims stacking.

The method may comprise a step of completing the set of shims. This will help in getting one better extraction from the computing device, or in getting many extractions.

The method may comprise a step of gathering the extracted shims according to a single extraction. The last is a priori the most relevant. With only one extraction, the user can work quickly and confidently.

The method may comprise a step of making a choice between at least two extractions and gathering the shims according to the choice. This can be interesting to diversify the residual stock of shims. The last can be used for other machines.

The invention is also directed to a set of shims needed when performing an alignment of shafts of a first machine and a second machine. The set comprises at least a 0.05 mm shim, a 0.1 mm shim, a 0.2 mm shim, a 0.25 mm shim, a 0.4 mm shim, a 0.5 mm shim, a 0.7 mm shim, a 1 mm shim, a 2 mm shim, and a 3 mm shim. As discussed hereinafter, this selection of values allows a lot of combinations of shims to achieve a recommended value.

A further aspect of the disclosure includes a method of aligning a shaft of a first machine and a shaft of a second machine that involves a) determining a total required shim thickness needed to raise a portion of the first machine relative to a first machine support to align the shaft of the first machine with the shaft of the second machine, b) providing a set of shims, each of the shims having a thickness, c) providing to a computer processor the thickness of each shim in the set of available shims, d) automatically determining by the computer processor at least one subset of the set of available shims required to provide the total required shim thickness, e) selecting one of the at least one subset of shims from the set of available shims, and f) inserting one of the at least one subset of shims between the portion of the first machine and the first machine support. The subset of shims many comprise no more than three shims and/or after inserting the subset of shims, updating the set of available shims to remove the selected subset of shims from the set of available shims.

Complicated and time-consuming alignment process according to prior art has been, thanks to the invention, changed to simple and quick process.

### DETAILED DESCRIPTION

In the following, the invention will be explained in greater detail without FIGURES.

A preferred embodiment of a method of selecting shims, when performing an alignment of shafts, concerns any type of machine. For example, a first machine can be a driving machine such as a motor while a second machine can be a driven machine such as a gear box or a pump.

The method includes providing to a computing device parallel and/or angular misalignment values between the shafts of the first and the second machines. Misalignment measurement methods are well known, and examples have been mentioned before.

A suitable computing device may be a programmable hardware component such as a processor, a microprocessor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The method further includes providing to the computing device the values of the thicknesses of each shim of an available set of shims. The following table is an example of an available set of shims according to the disclosure.

| Shim | Shim thickness |
|---|---|
| reference | in mm |
| a | 3 |
| b | 2 |
| c | 1 |
| d | 0.7 |
| e | 0.5 |
| f | 0.4 |
| g | 0.25 |
| h | 0.2 |
| i | 0.1 |
| j | 0.05 |

By way of non-limiting example, a desired shim thickness may be determined to be 2.41 mm. The computing device, thanks to an algorithm, can recommend a set of shims according to a calculation made using a mathematical formula. These calculation can come from the Vlookup function of excel, a Boolean program, or any equivalent means.

The calculation gives a recommendation R which is the sum of B plus M plus T, B being the thickness of the bottom shim, M being the thickness of the middle shim, and T being the thickness of the top shim. B is greater or equal to M, and M is greater or equal to T.

For example, a suitable algorithm may comprise: a) providing to a computer processor the thickness of each shim in a set of available shims, b) determining a total thickness of shims required (TTR) to make a necessary adjustment, c) selecting from the set of available by the computer processor the thickest available shim that has a thickness less than or equal to the total thickness required (TTR) as the bottom shim B, d) updating the set of available shims to remove the shim selected as the bottom shim B, e) subtracting the thickness of the bottom shim B from the total thickness required to obtain a first remaining thickness required (RTR1), f) if RTR1 is greater than 0, selecting the thickest shim available in the updated set of available shims that has a thickness less than or equal to the first remaining thickness RTR1 as the middle shim M, g) updating the set of available shims to remove the shim selected as the middle shim M, h) adding the thicknesses B+M, i) subtracting the sum of B+M from the total required thickness to obtain a second remaining thickness required (RTR2), j) if the second remaining thickness RTR2 is greater than 0, selecting the thickest shim available in the updated set of available shims that has a thickness less than or equal to (RTR2) as the top shim T and h) placing the bottom, middle and top shims between a support and a foot of the machine to be adjusted.

In the given example, the thickness of the bottom shim is 2 mm, and the thickness of the middle shim is 0.4 mm. Because the set does not contain a 0.01 mm shim, the recommendation does not include a top shim. In other words, the recommendation is to use only two shims, and the extraction can follow the recommendation. The foregoing is visualized in the table below.

| | | | Recommended |
|---|---|---|---|
| Bottom | Middle | Top | approximation |
| shim (B) | shim (M) | shim (T) | R = B + M + T |
| 2 | 0.4 | 0 | 2.4 |

In another example, thickness to achieve is 1.75 mm. In this case, several recommendations are possible and visualized in the table below. A first possibility is a 1 mm bottom shim, a 0.5 mm middle shim, and a 0.25 mm top shim. A second possibility is a 1 mm bottom shim, a 0.7 mm middle shim, and a 0.05 mm top shim. Both recommendations are given for three shims.

| | | | Recommended |
|---|---|---|---|
| Bottom | Middle | Top | approximation |
| shim (B) | shim (M) | shim (T) | R = B + M + T |
| 1 | 0.5 | 0.25 | 1.75 |
| 1 | 0.7 | 0.05 | 1.75 |

In addition, the computing device can document the values, which can be and used as a benchmark for future alignment inspections. The computing device can be designed to come with a built-in step-by-step alignment process, from preparation, inspection, and evaluation through correction, reporting and analysis. Alignment information including shim selection data can still be exported to a database to store data regarding visual inspections on oil leakage, oil level, foundation bolt status, and wear indications.

While a preferred embodiment has been described, according to the disclosure, it is realized that variations and modifications within the scope of the attached claims may exist.

For example, the set can contain more shims or less shims. And sometimes the computing device may give only one recommendation, or even none. If it is not possible to find a good combination, the best way to go is to complete the shim set.

The disclosure may advantageously be used in all applications where two shafts must be aligned plane-parallel or essentially plane-parallel.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods of selecting shims from a set of available shims.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method of aligning a shaft of a first machine and a shaft of a second machine comprising:
a) determining a total required shim thickness needed to raise a portion of the first machine relative to a first machine support to align the shaft of the first machine with the shaft of the second machine,
b) providing a set of shims, each of the shims having a thickness,
c) providing to a computer processor the thickness of each shim in the set of available shims,
d) automatically determining by the computer processor at least one subset of the set of available shims required to provide the total required shim thickness,
e) removing one of the at least one subset of shims from the set of available shims, and
f) inserting the one of the at least one subset of shims between the portion of the first machine and the first machine support.

2. The method according to claim 1,
wherein the subset of shims includes no more than three shims.

3. The method according to claim 1,
wherein determining a total required shim thickness comprise measuring a misalignment amount.

4. The method according to claim 2
including, after inserting the subset of shims, updating the set of available shims to remove the one of the at least one subset of shims,
determining a total required shim thickness required to raise a third machine relative to a fourth machine to align a shaft of the third machine with a shaft of the fourth machine, and
repeating steps b)-f).

5. The method according to claim 2, further including:
after inserting one of the at least one subset of shims, adding new shims to the set of available shims to replace the selected shims.

6. The method according to claim 2,
wherein the inserting the one of the at least one subset of shims comprises inserting the one of the at least one subset of shims simultaneously.

7. The method according to claim 2,
wherein the at least one subset of the set of available shims comprises two different subsets of the set of available shims.
